(19) United States
(12) Patent Application Publication
(10) Pub. No.: US 2015/0168784 A1
(43) Pub. Date: Jun. 18, 2015

(54) LIQUID CRYSTAL DISPLAY DEVICE

(71) Applicant: Japan Display Inc., Minato-ku (JP)

(72) Inventor: Seiji ASADA, Minato-ku (JP)

(73) Assignee: Japan Display Inc., Minato-ku (JP)

(21) Appl. No.: 14/570,168

(22) Filed: Dec. 15, 2014

(30) Foreign Application Priority Data
Dec. 16, 2013 (JP) 2013-258959

(51) Int. Cl. G02F 1/1335

(52) U.S. Cl. CPC G02F 1/133608; G02F 1/133536; G02F 1/133504

(57) ABSTRACT

According to one embodiment, a liquid crystal display device includes a liquid crystal display panel and a planar light source device. At least a display region portion of the liquid crystal display panel is formed in a curved configuration. The planar light source device emits light at a back surface of the liquid crystal display panel. A display surface of the liquid crystal display panel is disposed to have a configuration curved away from the planar light source device. A polarized reflective member is disposed between the liquid crystal display panel and the planar light source device.

### CROSS-REFERENCE TO RELATED APPLICATIONS

This application is based upon and claims the benefit of priority from Japanese Patent Application No.2013-258959, filed on Dec. 16, 2013; the entire contents of which are incorporated herein by reference.

### FIELD

This invention relates to a liquid crystal display device including a liquid crystal display panel that has a curved display surface and a planar light source device that has a planar type.

### BACKGROUND

Currently, liquid crystal display devices are widely employed in color televisions, personal computers, image display monitors, mobile telephones, etc., to reduce the weight, thickness, power consumption, etc. Such a liquid crystal display device has a configuration in which a liquid crystal display panel is combined with a surface light source device disposed on the backside of the liquid crystal display panel; and an image is displayed on the display surface of the liquid crystal display panel by the liquid crystal display panel transmitting or blocking the light projected from the surface light source device.

In such a liquid crystal display device, the display surface of the liquid crystal display panel that is used generally has a planar configuration; but in recent years, a liquid crystal display panel that has a curved display surface is being developed for many applications. Although the liquid crystal display panel that is curved is used in combination with a surface light source device that is similarly curved, there are liquid crystal display devices described in Patent Document 1 (JP-A 2010-217702 (Kokai)) and Patent Document 2 (JP-A 2004-46254 (Kokai)) in which only the liquid crystal display panel is formed to be curved, and the liquid crystal display panel is combined with a planar light source device in which the surface light source device is formed in a planar configuration.

### BRIEF DESCRIPTION OF THE DRAWINGS

FIG. 1 is a decomposed perspective view schematically showing a liquid crystal display device of an embodiment;

FIG. 2 is a cross-sectional view showing the liquid crystal display device of the embodiment;

FIG. 3 is a cross-sectional view schematically showing the configuration of a polarized reflective member forming the liquid crystal display device of the embodiment;

FIG. 4 is an explanation drawing for describing the travelling state of light that is incident on the liquid crystal display device and emitted from a planar light source device of the liquid crystal display device of the embodiment;

FIG. 5 is an explanation drawing for describing the travelling state of light in case of changing an angle to be set in the polarized reflective member of the embodiment; and

FIG. 6 is a cross-sectional view showing another configuration example of the planar light source device forming the liquid crystal display device of the embodiment.

### DETAILED DESCRIPTION

According to one embodiment, a liquid crystal display device includes a liquid crystal display panel and a planar light source device. At least a display region portion of the liquid crystal display panel is formed in a curved configuration. The planar light source device emits light at a back surface of the liquid crystal display panel. A display surface of the liquid crystal display panel is disposed to have a configuration curved away from the planar light source device. A polarized reflective member is disposed between the liquid crystal display panel and the planar light source device.

A liquid crystal display device according to an embodiment will now be described in detail with reference to the drawings.

A liquid crystal display device will now be described as the liquid crystal display device of the embodiment in which a liquid crystal display panel is combined with a planar light source device having a planar configuration, and a display region of the liquid crystal display panel has a curved surface protruding in an outward direction (toward the viewing side) with respect to the planar light source device.

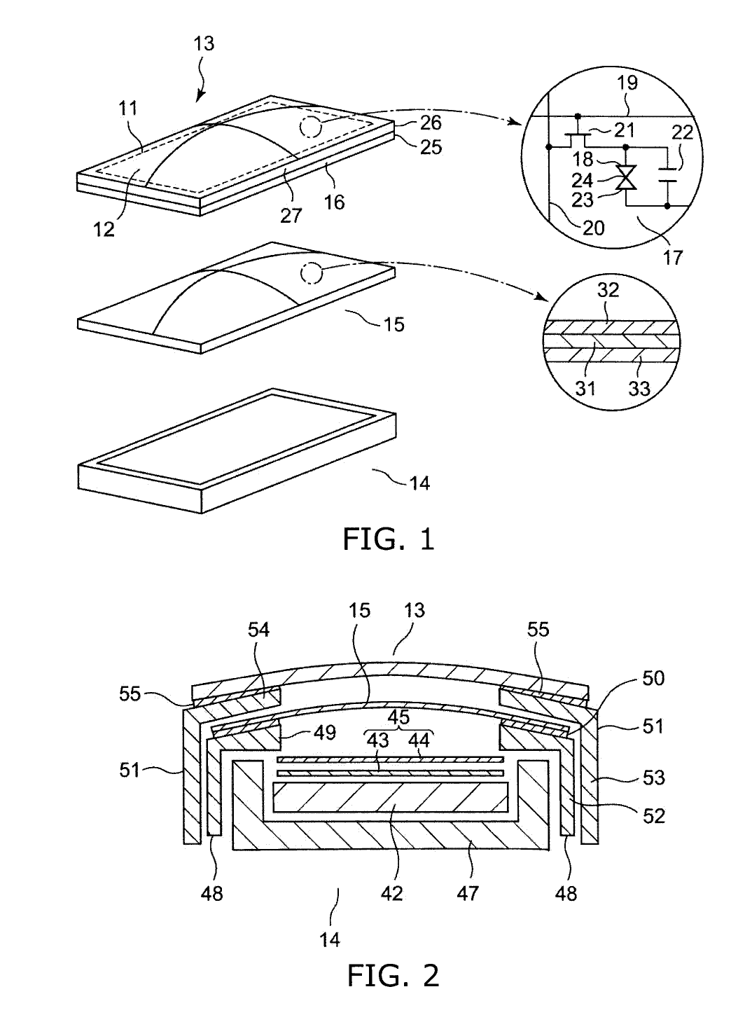

As shown in FIG. 1, the liquid crystal display device includes a liquid crystal display panel 13 including a display region 12; a frame region 11 is formed at the periphery of the liquid crystal display panel 13; the frame region 11 is provided around the display region 12; and the display region 12 is curved in a configuration protruding in the front outward direction (toward the viewing-direction side). A planar light source device (a backlight) 14 is disposed on the backside (the side opposite to the viewing side) of the liquid crystal display panel 13. A polarized reflective member 15 is interposed between the liquid crystal display panel 13 and the planar light source device 14.

The curved solid lines that are drawn on the liquid crystal display panel 13 and the polarized reflective member 15 in the drawing respectively show that the liquid crystal display panel 13 and the polarized reflective member 15 are curved in the solid line direction for both the major axis and the minor axis; but configurations also are possible in which the curvature is only in one direction of the major axis or the minor axis.

In the liquid crystal display panel 13, transparent pixel electrodes 18 included in display pixels 17 made of indium tin oxide (ITO), etc., are disposed in a matrix configuration on a major surface of a transparent insulating substrate 16 including a flexible material such as a glass material, a synthetic resin material, etc. Multiple scanning lines 19 are disposed in the row direction of the pixel electrodes 18; and multiple signal lines 20 are disposed in the column direction of the pixel electrodes 18.

Multiple TFTs 21 are provided as switching elements at the vicinity of the intersecting positions between the scanning lines 19 and the signal lines 20 corresponding to the pixel electrodes 18. The gate electrode of the TFT 21 is connected to the scanning line 19 formed along the row of the pixel electrode 18; the source electrode or the drain electrode of the TFT 21 is connected to the signal line 20 formed along the column of the pixel electrode 18; and the TFT 21 operates by the TFT 21 being turned on by a drive voltage supplied from a scanning line drive circuit (not shown) via the scanning line 19 to apply, to the pixel electrode 18 via the source-drain path of the TFT 21, a signal voltage supplied from a signal line drive circuit (not shown) via the signal line 20.

One end of a storage capacitor 22 is connected to the pixel electrode 18 in parallel; the other end of the storage capacitor 22 is connected to a common electrode 23 or connected to a supplemental capacitance line or a scanning line of the previous or latter stage; and a liquid crystal layer 24 is disposed between the pixel electrode 18 and the common electrode 23. An array substrate 25 is formed by further providing an alignment film (not shown) including polyimide, etc., on the upper surface of the TFTs 21, the pixel electrodes 18, and the drive lines such as the scanning lines 19, the signal lines 20, etc.

In a counter substrate 26 that opposes the array substrate 25, a transparent insulating substrate 27 that similarly includes a flexible material such as a glass material, a synthetic resin material, etc., is provided; the transparent common electrode 23 includes ITO, etc., and is provided on the major surface of the transparent insulating substrate 27 opposing the array substrate 25; a black light-shielding film (not shown) is provided in the peripheral portion of the transparent common electrode 23; and an alignment film (not shown) made of polyimide, etc., is provided on the upper surface of the common electrode 23.

The counter substrate 26 is formed by providing, in the portion of the transparent insulating substrate 27 enclosed with the light-shielding film, a three primary-color filter (not shown) including an acrylic material, etc., and a black matrix (not shown) for blocking the light leaking from the gaps between the interconnects. It is also possible to form the color filter on the array substrate 25 side.

The array substrate 25 and the counter substrate 26 are opposingly arranged at a prescribed gap and are bonded to each other by a sealant (not shown); and a liquid crystal layer 24 is formed by a liquid crystal member being sealed in the gap unit. The thickness of the liquid crystal layer 24 is specified by a spacer (not shown) interposed between the array substrate 25 and the counter substrate 26; and the liquid crystal display panel 13 that includes the curved display region 12 is formed.

On the other hand, the polarized reflective member 15 that has a sheet configuration in which a polarizing layer (DBEF (Dual Brightness Enhanced Film)) 31 is interposed between diffusion film layers 32 and 33 is disposed at the back surface on the array substrate 25 side. Because the polarizing layer 31 is formed to be thin, it is possible to reinforce the polarizing layer 31 and suppress scratching by providing the diffusion film layers 32 and 33 on the sides of two surfaces of the polarizing layer 31 in a sandwich configuration.

By using the diffusion film layers 32 and 33, it is possible not only to reduce the difference between viewing angles and widen the viewing angle by the diffusion but also to suppress a display in which a glarish appearance undesirably occurs and improve the uneven luminance.

The planar light source device 14 that has the planar configuration is disposed on the backside of the polarized reflective member 15 which is the side opposite to the liquid crystal display panel 13.

As shown in FIG. 2 and FIG. 6, the planar light source device 14 includes a light guide plate 42 that is configured in a flat plate configuration that receives light from a light source 41 made of an LED, a reflector, etc., and emits the light in a planar configuration; and the planar light source device 14 includes an optical sheet 45 of a diffusion sheet 43, a lens sheet 44, etc., sequentially disposed on the emission surface side of the light guide plate 42. Although the optical sheet 45 includes the two sheets of the diffusion sheet 43 and the lens sheet 44, it is possible to interchange the order or omit one of the sheets; it is possible to add other sheets such as a polarized sheet, etc.; and the types and configurations are not particularly limited. Other than the form in which such a light guide plate 42 is used, the planar light source device 14 may be made of an EL element or have a configuration in which LEDs are multiply disposed in parallel in a planar configuration; and the configuration of the planar light source device 14 is not limited.

On the other hand, a reflective sheet 46 (referring to FIG. 6) is disposed on the non-emission surface side of the light guide plate 42; the reflective sheet 46, the light guide plate 42, the optical sheet 45, the light source 41, etc., are collectively contained inside a back case 47 having a box configuration; a front case 48 engages from the open surface side of the back case 47 to fixedly hold the light emitting component members inside the back case 47; and the central portion of the front case 48 is configured to have an opening 49 so that the light that is emitted passes through the polarized reflective member 15 and passes through to the liquid crystal display panel 13 side

As shown in FIG. 6, it is possible to further increase the utilization efficiency of the light by disposing the reflective sheet 46 not only on the bottom surface portion of the light guide plate 42 but also on all side surfaces of the light guide plate 42 except where the light source 41 exists.

The liquid crystal display panel 13 surface side of the front case 48, i.e., the outer surface of the opening 49 edge portion, is formed to be curved to conform to the curved configuration of the liquid crystal display panel 13 that is formed in the curved configuration. The inner surface side of the opening 49 edge portion is formed to be substantially perpendicular to the front case 48 side surface because the front case 48 holds the back case 47 on the inside; and it is possible to easily form the opening 49 edge portion as one body from a material such as a synthetic resin, etc., so that the outer surface side of the opening 49 edge portion is curved.

However, instead of the formation as one body, it is also possible to form the opening 49 edge portion having the curved surface by a method such as forming the opening 49 edge portion of the front case 48 to have a constant wall thickness and then integrating with a frame body (not shown) formed as a separate entity having a curved surface by covering the outer side of the opening 49 edge portion with the frame body, bonding the frame body to the outer side of the opening 49 edge portion, etc.

The polarized reflective member 15 is mounted to the outer surface of the opening 49 edge portion, i.e., the surface on the liquid crystal display panel 13 side, by double-sided adhesive tape 50, etc. The entire polarized reflective member 15 is formed to have a curved surface that conforms to the curved surface of the liquid crystal display panel 13 that has the curved surface. Accordingly, being formed in a sheet configuration is considered to be convenient during use.

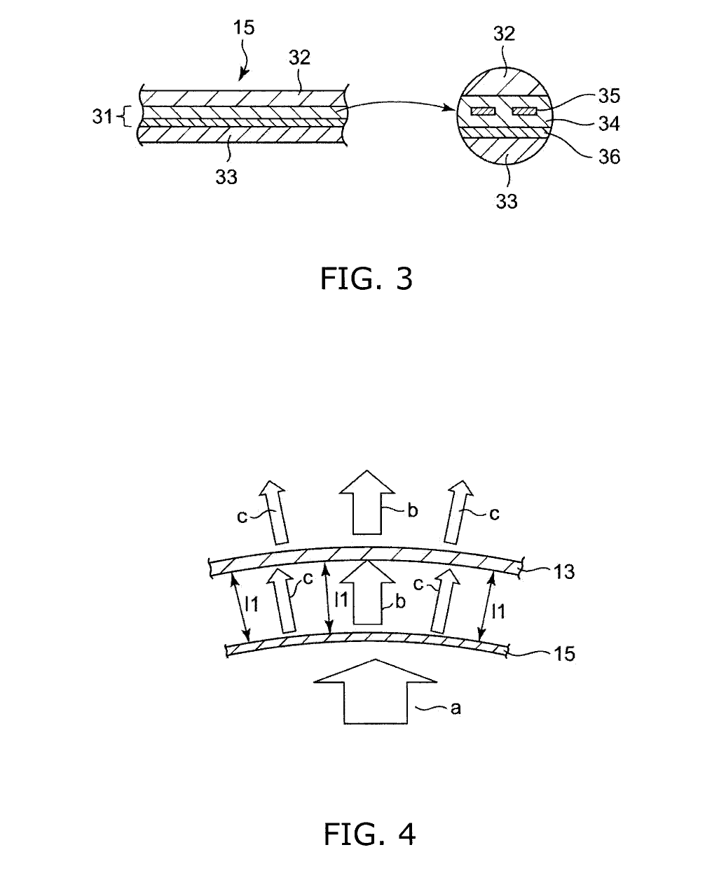

Although the polarized reflective member 15 is described when describing the overview of the liquid crystal display device of FIG. 1, more detail of the configuration of the polarized reflective member 15 is shown in FIG. 3.

Namely, a configuration is formed in which the diffusion film layers 32 and 33 are provided on the sides of two surfaces of a polarizing layer (DBEF) (31) formed by a material made of reflective particles 35 mixed into a resin layer 34 being coated onto a base material 36 such as a PET film, etc. The reflective particles 35 are formed from a material that transmits the light, e.g., P polarized light, in the same direction as (parallel to) the polarizing axis and reflects the light, e.g., S polarized light, in directions different from the polarizing axis. Here, the light that is reflected returns in the direction of the optical sheet 45 and the light guide plate 42, is reflected by the reflective sheet 46 or by each of the members, again reaches the polarized reflective member 15, and is transmitted or reflected; and the light efficiency is increased by repeating this operation.

Although the polarizing layer 31 is formed by using the base material 36 in the description herein, a configuration is possible in which the base material 36 is omitted and the polarizing layer 31 is directly coated onto the film surface of the diffusion film layer 32 or 33.

By the polarized reflective member 15 having such a configuration, it is possible for the diffusion film layers 32 and 33 to simultaneously protect and mechanically reinforce the polarizing layer 31 which is easily scratched; a wider viewing angle is possible; and it is possible to improve the uneven luminance. Also, a display is possible in which the difference between viewing angles is reduced and the glarish appearance is suppressed.

The polarized reflective member 15 is positionally fixed on the outer surface of the opening 49 edge portion of the front case 48 by a holding case 51 having a similarly-curved surface. The holding case 51 includes a side plate 53 conforming to a side plate 52 of the front case 48, and an edge portion 54 formed at an end portion of the side plate 53 at one end on the liquid crystal display panel 13 side. The inner and outer surfaces of the edge portion 54 are formed to have substantially the same curved configuration as the curved surface of the liquid crystal display panel 13.

In other words, the polarized reflective member 15 is held between the opening 49 edge portion of the front case 48 and the edge portion 54 of the holding case 51; and the liquid crystal display panel 13 is fixedly disposed on the outer surface of the edge portion 54 of the holding case 51 by double-sided adhesive tape 55, etc. As a result, for the curved surface of the liquid crystal display panel 13 and the curved surface of the polarized reflective member 15, it is possible to set the spacing between the display region 12 portion of the liquid crystal display panel 13 and the light transmission portion of the polarized reflective member 15 to be substantially constant.

The back case 47 and the front case 48 can be configured as one body by a structure in which a hook-shaped portion (not shown) formed in one of the back case 47 or the front case 48 engages an opening (not shown) made in the other; and it is possible to employ a similar configuration to cause the front case 48 to engage the holding case 51.

By employing such a configuration as shown in FIG. 4, light a that is emitted from the planar light source device 14 is caused to be incident on the polarized reflective member 15; but because the light a that is caused to be squarely incident is, by the diffusion film layers 32 and 33, emitted in perpendicular directions corresponding to the curved surface of the polarized reflective member 15, it is possible to emit the light a uniformly as illustrated by arrows b and c toward the liquid crystal display panel 13 that is formed to be curved.

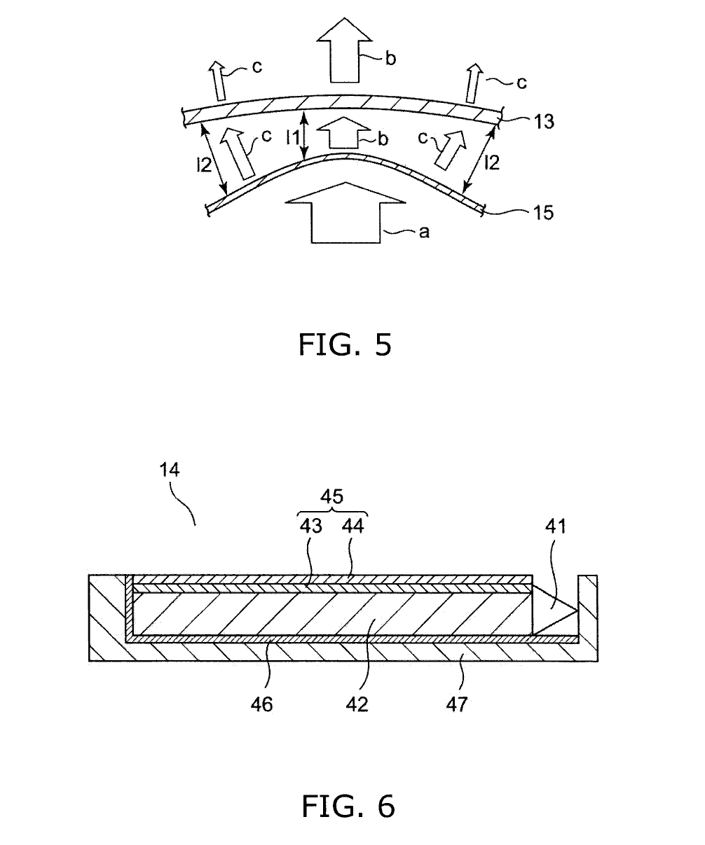

However, as shown in FIG. 5, in the case of a spacing I2 where a spacing I1 between the liquid crystal display panel 13 and the polarized reflective member 15 is nonuniform, the perpendicular light a emitted from the polarized reflective member 15 is not perpendicularly incident on the liquid crystal display panel 13, which causes the light to decrease; and this phenomenon for the entire liquid crystal display panel 13 results in a coexistence of dense portions of light and sparse portions of light, which promotes uneven luminance and reduced luminance.

Therefore, it is possible to suppress the uneven luminance and the reduced luminance by setting the spacing between the curved liquid crystal display panel 13 and the curved polarized reflective member 15 to be substantially equal by setting I1=I2 or I1≅I2, that is, by setting the curvatures of the surfaces of the liquid crystal display panel 13 and the polarized reflective member 15 that oppose each other to be equal or substantially equal. Because a configuration is employed in which the diffusion film layers 32 and 33 hold the polarizing layer (DBEF) 31 from two sides to provide the polarized reflective member 15 with the same curved configuration as the liquid crystal display panel 13, the configuration is exceedingly advantageous for forming the curved configuration in addition to the effect of uniformly transmitting the light. As a result, it is possible to use the planar light source device 14 having the planar configuration as the light source device with the liquid crystal display panel 13 which is formed to be curved; and because the light source device does not have a curved configuration similar to that of the liquid crystal display panel 13, it is possible to simplify the light source device; and effects are realized such as a basic configuration being used as-is by making a small adjustment of the front case 48 portion of a conventional planar light source device.

Although the case is described where a form is employed in which the polarized reflective member 15 is held by the front case 48 and the holding case 51, a configuration also is possible in which the polarized reflective member 15 is fixed directly to the liquid crystal display panel 13 by double-sided adhesive tape (not shown), etc.; and in the case of such a configuration, it is possible to further reduce the loss of the light because the spacing between the liquid crystal display panel 13 and the polarized reflective member 15 substantially can be ignored.

Further, in the case where such a configuration is employed, it is possible to simplify the configuration further by omitting one of the holding case 51 or the front case 48 and using the other to provide both functions.

Configurations other than those described above are applicable to the configurations of the array substrate 25 and the counter substrate 26; and additions and modifications may be performed as appropriate without departing from the spirit of the invention.

According to the embodiments, a liquid crystal display device can be provided in which a curved liquid crystal display panel is used in combination with a planar light source device having planar configuration, and uneven luminance can be improved while preventing the front luminance from decreasing.

Moreover, all liquid crystal display devices practicable by an appropriate design modification by one skilled in the art based on the liquid crystal display devices described above as embodiments of the invention also are within the scope of the invention to the extent that the spirit of the invention is included.

What is claimed is:

1. A liquid crystal display device, comprising:
a liquid crystal display panel, at least a display region portion of the liquid crystal display panel being formed in a curved configuration; and
a planar light source device emitting light at a back surface of the liquid crystal display panel,
a display surface of the liquid crystal display panel being disposed to have a configuration curved away from the planar light source device,
a polarized reflective member being disposed between the liquid crystal display panel and the planar light source device.

2. The device according to claim 1, wherein a distance between the liquid crystal display panel and the polarized reflective member is substantially equal inside the display region portion of the liquid crystal display panel.

3. The device according to claim 1, wherein the polarized reflective member includes a reflective member and a plurality of diffusion film layers, the reflective member including a reflective material, the plurality of diffusion film layers holding the reflective member from two sides.

4. The device according to claim 1, wherein the liquid crystal display panel and the polarized reflective member are assembled as one body.

5. The device according to claim 1, wherein
the planar light source device includes a front case and a holding case, the front case fixedly holding a light source, the holding case fixedly disposing the liquid crystal display panel, at least a portion of the holding case having a curved configuration, and
the polarized reflective member is disposed between the front case and the holding case.

6. The device according to claim 5, wherein
the polarized reflective member is fixed between an opening edge portion of the front case and an edge portion of the holding case, and
the liquid crystal display panel is fixedly disposed on an outer surface of the edge portion of the holding case.

7. The device according to claim 1, wherein the polarized reflective member is fixed to the liquid crystal display panel.
